(19) United States
(12) Patent Application Publication
(10) Pub. No.: US 2025/0018895 A1
(43) Pub. Date: Jan. 16, 2025

(54) THEFT PREVENTION DEVICE FOR AUTOMOBILES

(71) Applicants: Russell William Howell, Petawawa (CA); Derek Lapierre, Pembroke (CA)

(72) Inventors: Russell William Howell, Petawawa (CA); Derek Lapierre, Pembroke (CA)

(21) Appl. No.: 18/350,234

(22) Filed: Jul. 11, 2023

(51) Int. Cl. B60R 25/00

(52) U.S. Cl. CPC B60R 25/006

(57) ABSTRACT

A vehicle anti-theft device that is configured to be surroundably mount a brake pedal inhibiting access thereto and as such disabling features of the vehicle such as but not limited to starting of the vehicle. The invention includes a housing having a plurality of walls forming an interior volume being of suitable size to accommodate a vehicle brake pedal therein. The housing includes a front wall that is hingedly mounted operable to move between an open and closed position. A top wall is slidably secured to the housing so as to facilitate placement of the housing around the vehicle brake pedal. A wedge member is placed within the interior volume of the housing and is configured to engage the brake pedal applying an upwards bias thereagainst so as to inhibit movement of the vehicle brake pedal. A lateral stability member is secured to the housing to inhibit lateral movement thereof.

### FIELD OF THE INVENTION

The present invention relates generally to automobile theft prevention, more specifically but not by way of limitation, a device that is configured to surroundably mount the brake pedal of the vehicle so as to inhibit operation thereof and as such immobilize the automobile.

### BACKGROUND

In North America automobile theft continues to be a significant issue. From 2019 to 2022 automobile theft in North America increased by almost twenty percent wherein the annual total of stolen vehicles now exceeds over one million cars. While automobile manufacturers have changed components such as but not limited to security key fobs and other technology, thefts of automobiles continue to be a problem. As is known in the art, most new cars are manufactured with a push button start feature wherein the car is wirelessly coupled to a secure key fob. In order to start the vehicle, the key fob must be present and the operator of the vehicle must depress the brake in order for the vehicle to start.

Current automobile thefts still occur in large part due to the ability of the automobile thieves to duplicate the wireless communication from the key fob making theft of the vehicle much easier. Once the duplicate key fob is successful, the thief can begin normal operation of the automobile. While there are anti-theft devices such as car alarms and tracking devices, these devices while sometimes successful are still unsuccessful in inhibiting some automobile theft. Current anti-theft devices focus on technology but fail to inhibit mechanical operation of parts of the vehicle which would result in more theft prevention.

Accordingly, there is a need for an anti-theft device for a vehicle wherein the anti-theft device is configured to surroundably mount a mechanical element such as the brake pedal in order to inhibit operation of the vehicle prior to removal thereof.

### SUMMARY OF THE INVENTION

It is the object of the present invention to provide an anti-theft device for an automobile that inhibits operation thereof unless removed wherein the present invention includes a housing having an interior volume.

Another object of the present invention is to provide an automobile theft prevention device that is configured to surroundably mount the brake pedal of the vehicle wherein the housing is manufactured having a plurality of walls forming an interior volume of sufficient size to accommodate the vehicle brake pedal therein.

A further object of the present invention is to provide an anti-theft device for an automobile that inhibits operation thereof unless removed wherein the housing includes a front wall that is hingedly moved from an open position to a closed position.

Yet a further object of the present invention is to provide an automobile theft prevention device that is configured to surroundably mount the brake pedal of the vehicle wherein the rear wall and the top wall of the housing have a brake pedal stem aperture formed therein.

Still another object of the present invention is to provide an anti-theft device for an automobile that inhibits operation thereof unless removed wherein the present invention includes a wedge member that is configured to be placed underneath the brake pedal disposed within the interior volume of the housing and bias thereagainst in an upwards direction.

An additional object of the present invention is to provide an automobile theft prevention device that is configured to surroundably mount the brake pedal of the vehicle wherein the housing further includes a gas pedal blocking member.

Yet a further object of the present invention is to provide an anti-theft device for an automobile that inhibits operation thereof unless removed wherein the housing is configured to be removable.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the present invention in its installed position; and

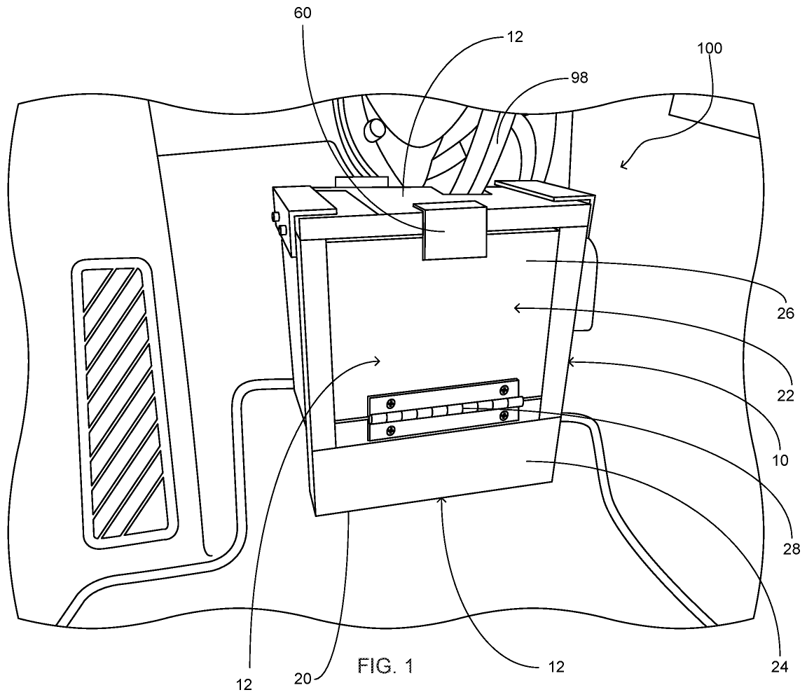

FIG. 2 is a front view of the present invention with the top wall removed; and

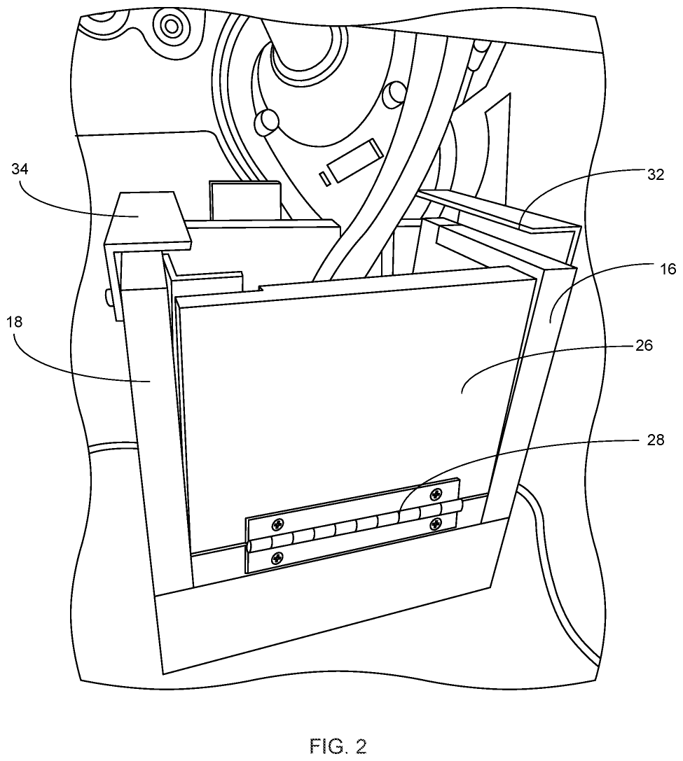

FIG. 3 is a front view of the present invention with the top wall removed and the front wall in an open position; and

FIG. 4 is a rear view of the present invention; and

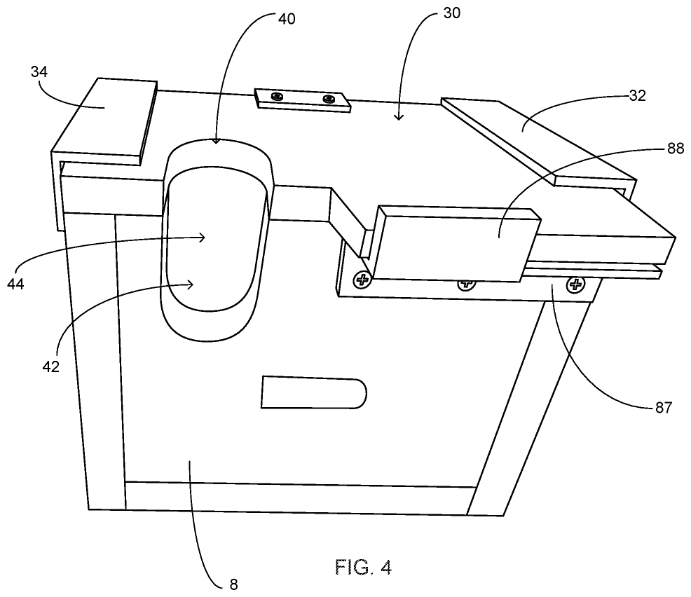

FIG. 5 is a front view of the present invention showing the gas pedal blocking member.

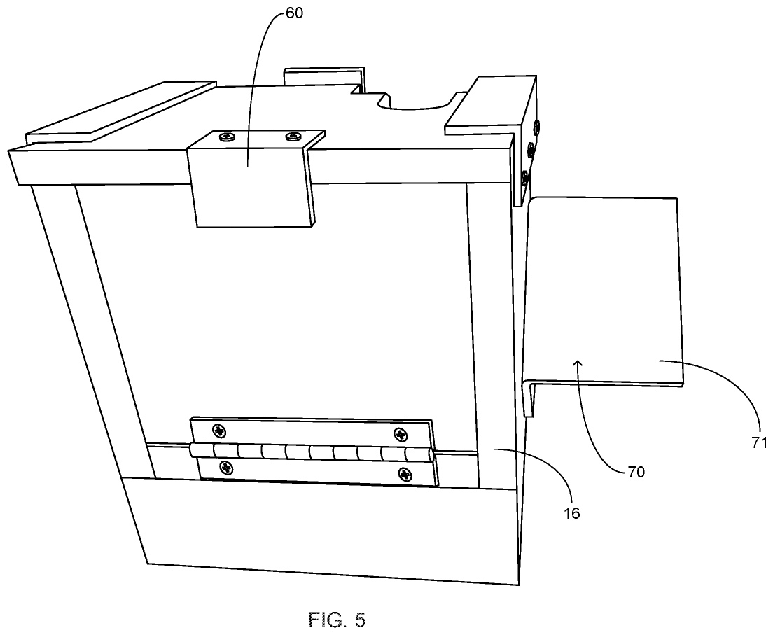

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle anti-theft device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

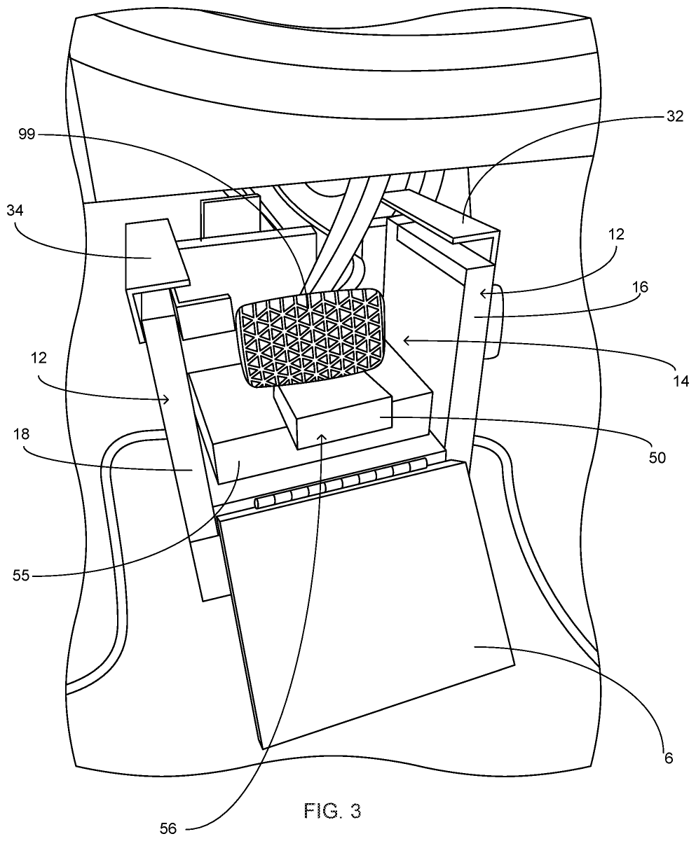

Referring in particular to the Figures submitted herewith, the vehicle anti-theft device 100 is configured to surroundably mount a brake pedal 99 of a vehicle and inhibit access thereto and operation thereof. The vehicle anti-theft device 100 includes a housing 10 wherein the housing 10 is manufactured from a durable rigid material. The housing 10 includes a plurality of walls 12 that are operably coupled utilizing suitable techniques to form an interior volume 14 of the housing 10. The housing 10 is manufactured of a suitable size so as to be surroundably mount the brake pedal 99 as is illustrated herein in FIG. 3. It should be understood within the scope of the present invention that the housing 10 could be manufactured on various sizes and shapes and still achieve the desired objective herein. The housing 10 includes opposing sidewalls 16, 18 and bottom 20. The front wall 22 includes a lower portion 24 and an upper portion 26. The upper portion 26 is hingedly secured to the lower portion 24 utilizing hinge 28. The upper portion 26 is configured to move between a closed position and an open position wherein the closed position releasably secures the housing 10 as is further discussed herein.

The housing 10 includes top wall 30 wherein the top wall 30 is slidably coupled to the opposing sidewalls 16, 18. The top wall 30 has progress thereof inhibited utilizing stop member 88 during installation thereof. Stop member 88 extends upward from rear wall 8 on mount 87 extending beyond an upper surface of the top wall 30. A first retention member 32 and a second retention member 34 are mounted proximate the upper edge of the opposing sidewalls 16,18. The first retention member 32 and second retention member 34 are L-shaped and extend above the upper edges of the opposing sidewalls 16,18 facilitating an ability to slide the top wall 30 therebetween and retain in position as is illustrated herein. It is contemplated within the scope of the present invention that the top wall 30 could be releasably secured to the housing 10 utilizing numerous suitable techniques. The top wall 30 has formed therein a first brake pedal mount indentation 40. The rear wall 8 has formed therein a second brake pedal mount indentation 42 wherein the first brake pedal mount indentation 40 and the second brake pedal mount indentation 42 conjoin to form the brake pedal mount aperture 44 ensuing assembly and placement of the housing 10. The brake pedal mount aperture 44 is configured to accommodate the brake pedal mount 98 therethrough during positioning and use of the vehicle anti-theft device 100.

Illustrated herein in FIG. 3 is wedge member 50. The wedge member 50 is wedge shaped and is manufactured from a durable rigid material. The wedge member 50 is superposed a support member 55 wherein support member 55 is superposed an upper surface of the bottom wall 20. The wedge member 50 has front portion that is wedge shaped (not particularly illustrated herein). The wedge member 50 is superposed the support member 55 and biased underneath brake pedal 99. The rear edge 56 of the wedge member 50 is positioned so as to engage the inner surface 6 of the upper portion 26 of the front wall 22 as the upper portion 26 is moved to its closed position. As the upper portion 26 reaches its upright position, the inner surface 6 is biased against the rear edge 56 of the wedge member 50 wherein wedge member 50 is biased against the brake pedal 99 having an upwards force on the brake pedal 99 and an opposing downwards force on the support member 55. The upward force on the brake pedal 99 ensures a position thereof that will disable use thereof for features such as but not limited to starting of the vehicle. The opposing downward pressure on the support member 55 functions to releasably secure the housing 10 in position so as to inhibit movement thereof. The upper portion 26 of the front wall 22 is locked into its closed position utilizing keeper 60. It should be understood within the scope of the present invention that the upper portion 26 could be secured into its closed position utilizing various locking and/or mechanical elements.

Secured to sidewall 16 is lateral stability member 70. The lateral stability member 70 includes a portion 71 that is perpendicular to the sidewall 16 extending outward therefrom. The lateral stability member 70 is manufactured from a durable rigid material. The lateral stability member 70 is operable to inhibit access to the gas pedal of a vehicle as well as bias against the mount thereof. The biasing against the gas pedal mount inhibits lateral movement of the vehicle anti-theft device 100 ensuing installation thereof. It should be understood within the scope of the present invention that various alternate elements could be employed to inhibit lateral movement of the vehicle anti-theft device 100 either in place of and/or in conjunction with the lateral stability member 70. While vehicle anti-theft device 100 is directed generally towards theft prevention, it should be understood be understood within the scope of the present invention that the vehicle anti-theft device 100 could be utilized to prevent unwanted/unintended operation of a vehicle by others such as but not limited to children.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A vehicle operation prevention device that is configured to inhibit operation of a vehicle until removal thereof wherein the vehicle operation prevention device comprises:
a housing, said housing having a plurality of walls, a bottom and a top forming an interior volume, said interior volume of said housing being of suitable size so as to accommodate a vehicle brake pedal therein, said housing being surroundably mounted the vehicle brake pedal, said housing having a front wall configured to move between a closed position and an open position providing access to said interior volume;
a wedge member, said wedge member being disposed in said interior volume of said housing, said wedge member being movable within said interior volume, said wedge member being intermediate an upper surface of the bottom of the housing and a lower edge of the brake pedal, said wedge member configured to bias against the lower edge of the brake pedal so as to inhibit movement thereof.

2. The vehicle operation prevention device that is configured to inhibit operation of the vehicle until removal thereof as recited in claim 1, wherein said front wall includes a lower portion and an upper portion, said upper portion being hingedly attached to said lower portion, said upper portion having a closed position and an open position.

3. The vehicle operation prevention device that is configured to inhibit operation of the vehicle until removal thereof as recited in claim 2, wherein said housing includes opposing side walls, said opposing sidewalls having retention members secured proximate a top edge thereof.

4. The vehicle operation prevention device that is configured to inhibit operation of the vehicle until removal thereof as recited in claim 3, wherein said top is slidably coupled to said housing along the top edge of said opposing sidewalls.

5. The vehicle operation prevention device that is configured to inhibit operation of the vehicle until removal thereof as recited in claim 4, wherein said retention members are configured to facilitate slidable coupling of said top to said housing.

6. The vehicle operation prevention device that is configured to inhibit operation of the vehicle until removal thereof as recited in claim 5, wherein said top has an indentation formed in a rear edge thereof, and wherein said housing includes a rear wall, said rear wall having an indentation formed therein, wherein said indentation of said top and said indentation of said rear wall are axially aligned to form a brake pedal mount aperture.

7. The vehicle operation prevention device that is configured to inhibit operation of the vehicle until removal thereof as recited in claim 6, wherein said housing further include a stop member, said stop member being secured to the rear wall proximate an upper edge thereof, said stop member extending upward from said rear wall, said stop member configured to inhibit the top from sliding therepast.

8. The vehicle operation prevention device that is configured to inhibit operation of the vehicle until removal thereof as recited in claim 7, and further including a lateral stability member, said lateral stability member being secured to said housing, said lateral stability member extending outward from said housing towards an acceleration pedal of the vehicle.

9. The vehicle operation prevention device that is configured to inhibit operation of the vehicle until removal thereof as recited in claim 8, wherein in said closed position an inner surface of said upper portion of said front wall is biased against a rear edge of said wedge member so as to inhibit movement of said wedge member.

10. The vehicle operation prevention device that is configured to inhibit operation of the vehicle until removal thereof as recited in claim 9, and further including a support member, said support member being intermediate said wedge member and the upper surface of said bottom of said housing.
